(19) United States
(12) Patent Application Publication
(10) Pub. No.: US 2026/0009433 A1
(43) Pub. Date: Jan. 8, 2026

(54) HYDRODYNAMIC RETARDER INCLUDING A FILLING TUBE

(71) Applicant: Voith Patent GmbH, Heidenheim (DE)

(72) Inventors: Dieter Laukemann, Frankenhardt (DE); Alexander Martin, Kressberg (DE); Martin Blumenstock, Frankenhardt (DE)

(73) Assignee: Voith Patent GmbH, Heidenheim (DE)

(21) Appl. No.: 19/324,353

(22) Filed: Sep. 10, 2025

Related U.S. Application Data
(63) Continuation of application No. PCT/EP2024/055941, filed on Mar. 7, 2024.

(30) Foreign Application Priority Data
Mar. 10, 2023 (DE) 10 2023 105 951.3

(51) Int. Cl. F16D 57/02; B60T 1/08

(52) U.S. Cl. CPC F16D 57/02; B60T 1/08

(57) ABSTRACT

A hydrodynamic retarder includes: a retarder chamber in which a rotor and a stator are arranged, the rotor and the stator together forming a working chamber for being filled with and emptied of a working medium; a working medium tank, which includes sump, storage, and expansion regions, the sump region and the storage region for accommodating the working medium that is not currently in working chamber; a filling channel for supplying the working medium into the working chamber, the filling channel being a tube including an inlet opening and an outlet opening; a return channel for discharging the working medium from the working chamber; a rotor housing; a stator housing; a tank housing; and an inlet chamber, the inlet opening terminating in the working medium tank, the outlet opening terminating in the inlet chamber, the inlet chamber being formed by the stator housing and the stator.

### CROSS REFERENCE TO RELATED APPLICATIONS

This is a continuation of PCT application no. PCT/EP2024/055941, entitled “HYDRODYNAMIC RETARDER COMPRISING A FILLING TUBE”, filed Mar. 7, 2024, which is incorporated herein by reference. PCT application no. PCT/EP2024/055941 claims priority to German patent application no. 10 2023 105 951.3, filed Mar. 10, 2023, which is incorporated herein by reference.

### BACKGROUND OF THE INVENTION

### 1. Field of the Invention

The present invention relates to hydrodynamic retarders.

### 2. Description of the Related Art

Hydrodynamic retarders includes a working chamber that can be filled with and emptied of working medium. A torque is transferred from a bladed rotor to a bladed stator with the assistance of the working medium. When the working chamber is filled, the rotor and thus a shaft that is designed to rotate with the rotor, for example a drive shaft or transmission output shaft that is indirectly connected to the wheels of a vehicle, is decelerated.

A retarder and its working medium circuit are known from DE 10 2013 006 611A1. The rotor and stator of the retarder form a toroidal working chamber, which is connected via a duct system to a working medium circuit with a working medium tank. Venting of the working chamber occurs via a ventilating system, through which air can escape into the environment through a connection between the working chamber and the environment. The working medium tank can be connected to a compressed air connection or the environment via a valve, the MRCU.

To switch the retarder to braking mode, the working medium tank must be supplied with compressed air via the MRCU, so that the working medium is moved via the filling channel from the working medium tank into the working chamber. The filling channel is arranged in the working medium tank in such a way that its inlet opening terminates in the lower region of the working medium tank, ensuring that the inlet opening of the filling channel is below the working medium level in any operating condition, preventing air from entering the filling channel.

When switching the retarder into non-braking mode, the working medium tank must be deventilated and the working chamber ventilated. The working medium is thereby pumped from the retarder via the heat exchanger back into the working medium tank.

What is needed in the art is a retarder with reduced manufacturing and assembly costs.

### SUMMARY OF THE INVENTION

The invention relates to the structure of a hydrodynamic retarder for a motor vehicle, in particular to the structure of the filling tube of the retarder.

The present invention provides a retarder including a retarder chamber in which a rotatably mounted rotor and a stator are arranged, which together form a working chamber that can be filled with and emptied of working medium. The retarder also includes a working medium tank which has a region to accommodate working medium that is not currently in the working chamber, and an expansion region, at least one filling channel for feeding working medium into the working chamber and a return channel for discharging working medium from the working chamber, as well as a rotor housing, a stator housing, and a tank housing.

The present invention provides that the filling channel is a tube having an inlet opening and an outlet opening, wherein the inlet opening terminates in the working medium tank and the outlet opening terminates in an inlet chamber, wherein the inlet chamber is formed by the stator housing and the stator.

The filling channel runs optionally essentially through the working medium tank, which significantly simplifies production.

The working medium tank can moreover include a sump region, wherein the inlet opening terminates in the sump region. Within the concept of the current invention, the sump region is a region that can accommodate a small volume of working medium compared to the working medium tank volume.

A coupling level can be provided on the tank housing, through which a first channel and a second channel are routed, wherein the coupling level is arranged below the sump region, and wherein a fluid-conducting connection with the primary side of a heat exchanger can be established by way of the channels. The heat exchanger can therein be connected directly or indirectly via a transition piece.

In one optional design, the outlet opening of the second channel is arranged in such a way that it terminates in the sump region. In this way, the working medium that is pumped through the heat exchanger and is cooled down enters the working medium tank first. It is also provided that the working medium tank forms a section of a fluid-conducting connection between the second channel and the filling channel. The gap created between the outlet of the second channel and the inlet opening of the filling channel has basically three functions:
1) when switching to braking mode:
   filling of the working chamber via the filling tube;
2) in braking mode:
   the gap forms a channel section of the working medium circuit;
3) when switching to non-braking mode:
   return of the working medium into the working medium tank.

It is advantageous, in particular in the braking mode, if the inlet opening of the filling channel and the outlet opening of the second channel are aligned with each other. Distance (x) between inlet opening and outlet opening is also decisive for the function. In this case, a distance (x) between 1 mm and 15 mm is advantageous.

It can be provided in particular that the inlet opening is designed in the shape of a funnel in order to further improve the flow progression through the working medium tank during braking operation.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a sectional sketch of a retarder; and

FIG. 2 is a filling tube in working medium tank.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

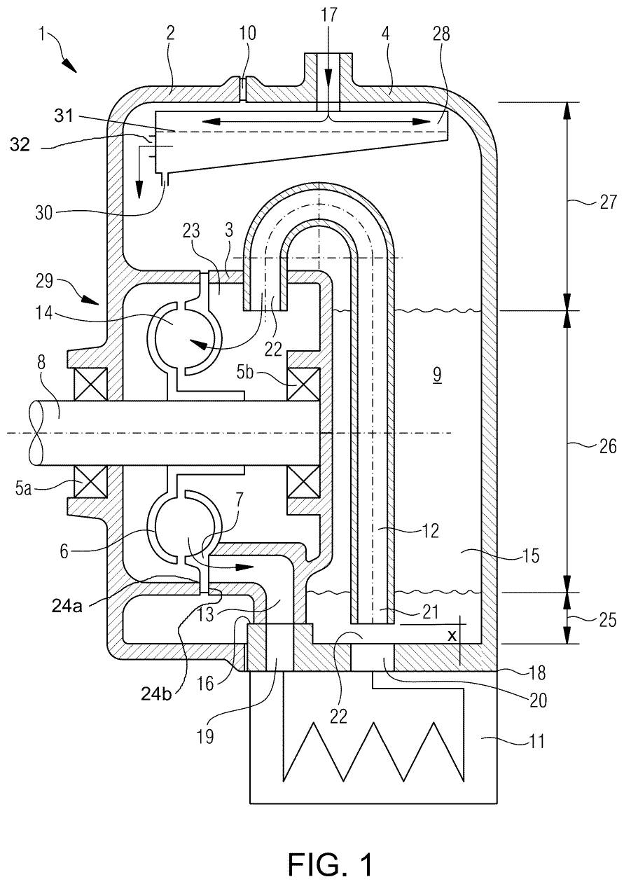

The sketch in FIG. 1 illustrates the basic structure of retarder 1. The outer enclosure of retarder 1 consists essentially of two parts: rotor housing 2 and stator housing 3, which respectively forms a half-shell of the housing. Housing parts 2 and 3 enclose a cavity, which is divided into three regions. Cavity region 27, storage region 26, and retarder region 29 are provided.

Together, cavity region 27, storage region 26, and retarder region 29 form working medium tank 15, wherein working medium 9 accumulates in storage region 26 and sump region 25 when the retarder is switched to non-braking mode.

Cavity region 27 is a space, designed essentially to ensure that no working medium can get into the compressed air control—also referred to as MRCU—via connection 17. A working medium separator or oil separator 28 is provided between connection 17 and working medium tank 15. Separated oil can flow back into working medium tank 15 via outlet 30.

During braking operation, the compressed air control regulates the braking torque of retarder 1. The higher the air pressure in cavity region 27 the more working medium 9 is forced from working medium tank 15 into the retarder circuit.

The region between rotor housing 2 and stator housing 3 is referred to as retarder region 29. Rotor 6, stator 7, bearing-mounted rotor shaft 8, and channels for conveying the working medium are located in retarder region 29. As is known from the current state of the art, rotor 6 can be arranged axially movable on rotor shaft 8.

A coupling level 18 is provided on tank housing 4, to which heat exchanger 11 can be attached directly or indirectly, wherein first channel 19 and second channel 20 are provided in coupling level 18. Via first channel 19, working chamber 14 is connected between rotor 6 and stator 7 to the flow connection of heat exchanger 11, and the outlet of heat exchanger 11 is connected to working medium tank 15 via second channel 20. Cooled working medium 9 enters working medium tank 15 via second channel 20 when switching to non-braking mode, in other words, when the pressure in expansion region 27 drops.

Moreover, a filling channel 12 is provided, which establishes a connection from lower sump region 25 into inlet chamber 23, which in turn is connected to working chamber 14 via channels in stator 7, not shown.

When switching the retarder into braking mode, the air pressure in expansion region 27 is increased via connection 17, as a result of which working medium 9 enters working chamber 14 via filling channel 12, inlet chamber 23, and the channels in stator 7. The known pumping action of retarder 1 causes working medium 9 to be pumped back from the working chamber via return channel 13, first channel 19, heat exchanger 11, and second channel 20 into working medium tank 15.

Filling channel 12 is arranged relative to second channel 20 in such a way that working medium 9 flowing out of second channel 20 can flow via inlet opening 21 into filling channel 12. In braking mode, this creates a circular flow, whereby working medium 9 flows over a short section through working medium tank 15. The distance between the outlet of second channel 20 and inlet opening 21 can be selected between 1 mm and 15 mm, wherein mixing of working medium 9 from the tank and working medium 9 from the circuit depends on the distance. Also, the minimum working medium level in working medium tank 15 must be above inlet opening 21 to ensure that no air enters into filling channel 12.

The pressure of the control air in expansion region 27 regulates the working medium volume in the circuit, which in turn determines the braking torque of the retarder. This control of the braking torque is standard and is therefore not discussed in further detail.

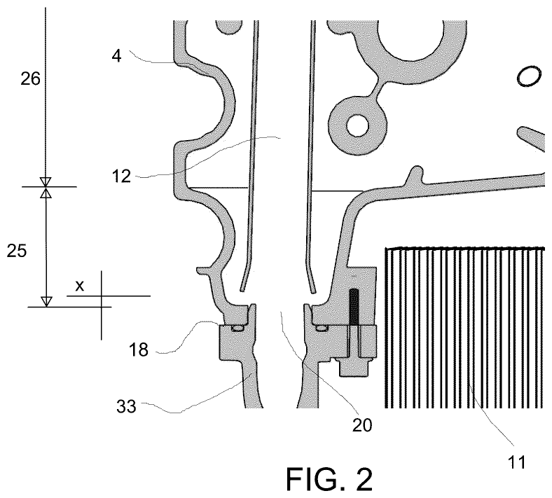

FIG. 2 shows the arrangement of the filler tube in working medium tank 15. This representation shows one possible design of working medium tank 15 with sump region 25. Sump region 25 is a small area located in the lower part of the tank, ensuring that a certain volume of working medium always remains in sump region 25, particularly during braking mode of the retarder. Since the end with inlet opening 21 of filler tube 12 terminates in the sump region, it is ensured that no air can enter working chamber 14 or the working medium circuit through filler tube 12.

Heat exchanger 11 is only indicated here, whereby an intermediate component 32 is provided, which connects the heat exchanger with tank housing 4 via connecting level 18. In this design, second channel 20 is integrated into the intermediate component 33. Moreover, channels are integrated into intermediate component 33, by way of which heat exchanger 11 is integrated into the working medium circuit.

As already mentioned, inlet opening 21 of filling channel 12 and outlet opening 22 of second channel 20 are aligned with each other and arranged at a distance x from each other. To achieve the most laminar flow possible of working medium 9 through working medium tank 15, inlet opening 21 is also designed in the shape of a funnel, so that the most laminar flow possible of the working medium through working medium tank 15 is achieved during braking mode.

### COMPONENT REFERENCE LISTING

1 Retarder
2 Rotor housing
3 Stator housing
4 Tank housing
5a, b Bearing
6 Rotor
7 Stator
8 Rotor shaft
9 Working medium
10 Seal
11 Heat exchanger
12 Filling channel
13 Return channel
14 Working chamber
15 Working medium tank
16 Coupling level
17 Connection
18 Connecting level
19 First channel
20 Second channel
21 Inlet opening
22 Outlet opening
23 Inlet chamber
24a, b Coupling level
25 Sump region
26 Storage region
27 Expansion region
28 Oil separator
29 Retarder chamber
30 Outlet
31 Structure element
32 Air passage
33 Intermediate component
X Distance

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A hydrodynamic retarder, comprising:
a stator;
a rotor, which is rotatably mounted;
a retarder chamber in which the rotor and the stator are arranged, the rotor and the stator together forming a working chamber that is configured for being filled with and emptied of a working medium;
a working medium tank, which includes a sump region, a storage region, and an expansion region, the sump region and the storage region being configured for accommodating the working medium that is not currently in working chamber;
at least one filling channel configured for supplying the working medium into the working chamber, the at least one filling channel being a tube including an inlet opening and an outlet opening;
a return channel configured for discharging the working medium from the working chamber;
a rotor housing;
a stator housing;
a tank housing; and
an inlet chamber, the inlet opening terminating in the working medium tank, the outlet opening terminating in the inlet chamber, the inlet chamber being formed by the stator housing and the stator.

2. The hydrodynamic retarder according to claim 1, wherein the at least one filling channel runs essentially through the working medium tank.

3. The hydrodynamic retarder according to claim 1, wherein the inlet opening terminates in the sump region.

4. The hydrodynamic retarder according to claim 1, further including a coupling level, a first channel, and a second channel, the coupling level being on the tank housing and being that through which the first channel and the second channel are routed, wherein the coupling level is arranged below the sump region, wherein the hydrodynamic retarder is configured for establishing a fluid-conducting connection with a primary side of a heat exchanger by way of the first channel and the second channel.

5. The hydrodynamic retarder according to claim 1, wherein the inlet opening terminates in the sump region, the hydrodynamic retarder further including a coupling level, a first channel, and a second channel, the coupling level being on the tank housing and being that through which the first channel and the second channel are routed, wherein the outlet opening of the at least one filling channel is a first outlet opening, wherein the second channel includes a second outlet opening that terminates in the sump region.

6. The hydrodynamic retarder according to claim 1, wherein the inlet opening terminates in the sump region, the hydrodynamic retarder further including a coupling level, a first channel, and a second channel, the coupling level being on the tank housing and being that through which the first channel and the second channel are routed, wherein the working medium tank includes a plurality of sections and, at least in the plurality of sections, a fluid-conducting connection between the second channel and the at least one filling channel.

7. The hydrodynamic retarder according to claim 1, wherein the inlet opening terminates in the sump region, the hydrodynamic retarder further including a coupling level, a first channel, and a second channel, the coupling level being on the tank housing and being that through which the first channel and the second channel are routed, wherein the outlet opening of the at least one filling channel is a first outlet opening, wherein the second channel includes a second outlet opening that terminates in the sump region, wherein the inlet opening of the at least one filling channel and the second outlet opening of the second channel are aligned with each other.

8. The hydrodynamic retarder according to claim 1, wherein the inlet opening terminates in the sump region, the hydrodynamic retarder further including a coupling level, a first channel, and a second channel, the coupling level being on the tank housing and being that through which the first channel and the second channel are routed, wherein the working medium tank includes a plurality of sections and, at least in the plurality of sections, a fluid-conducting connection between the second channel and the at least one filling channel, wherein the second channel includes a second outlet opening that terminates in the sump region, wherein a distance between the inlet opening and the second outlet opening is between 1 mm and 15 mm.

9. The hydrodynamic retarder according to claim 1, further including a coupling level, a first channel, and a second channel, the coupling level being on the tank housing and being that through which the first channel and the second channel are routed, wherein the coupling level is arranged below the sump region, wherein the hydrodynamic retarder is configured for establishing a fluid-conducting connection with a primary side of a heat exchanger by way of the first channel and the second channel, wherein the inlet opening is formed as a funnel.
